(19) United States
(12) Patent Application Publication
(10) Pub. No.: US 2025/0242795 A1
(43) Pub. Date: Jul. 31, 2025

(54) SYSTEM AND METHOD FOR ENGINE STALL RECOVERY AND RESTART FOR HYBRID ELECTRIC VEHICLE

(71) Applicant: FCA US LLC, Auburn Hills, MI (US)

(72) Inventors: Nadirsh Patel, Farmington Hills, MI (US); Ameya Busutkar, Auburn Hills, MI (US); Allwyn Bhakare, South Woodslee (CA); Ruben Martinelli, Belo Horizonte (BR); Naresh Sathyamoorthy, Chennai (IN)

(21) Appl. No.: 18/422,473

(22) Filed: Jan. 25, 2024

(51) Int. Cl. B60W 20/40; B60K 6/387; B60W 10/02; B60W 10/06; B60W 10/10; B60W 50/14

(52) U.S. Cl. CPC B60W 20/40; B60K 6/387; B60W 10/02; B60W 10/06; B60W 10/10; B60W 50/14; B60W 2510/0638; B60Y 2200/92

(57) ABSTRACT

A powertrain that generates and transfers drive torque to a driveline of a hybrid electric vehicle is provided. The powertrain includes an internal combustion engine (ICE), at least one electric motor and a controller. The powertrain is configured to selectively deliver drive torque from at least one of the ICE and the at least one electric motor to drive wheels, the powertrain having a clutch that selectively disengages the ICE from a remainder of the powertrain. The controller is configured to determine a stall condition of the ICE; command the clutch to disengage the ICE based on a determination of the stall condition; command the ICE to restart; determine whether the ICE has restarted; and operate the powertrain in a hybrid mode based on confirmation that the ICE has restarted.

### FIELD

The present application generally relates to hybrid electric vehicles and, more particularly, to a system and method for restarting an internal combustion engine of a hybrid electric powertrain after a detected stall event.

### BACKGROUND

A hybrid electric vehicle (HEV) is a type of hybrid vehicle that combines a conventional internal combustion engine system with an electric propulsion system. The engine in the HEV can be stopped and started multiple times during a drive cycle. The engine start-stop functionality in HEV's is a feature that automatically turns off the internal combustion engine when the vehicle comes to a stop, such as at traffic lights or in congested traffic, and restarting it when vehicle propulsion is needed again. Unlike a conventional 12 volt starter to crank the internal combustion engine, HEV's generally use high-voltage electric machines such a belt starter generator motor or integrated motors within a transmission to start the internal combustion engine.

In an HEV, if the internal combustion engine stalls while connected to the driveline, such as due to fuel, electrical or air intake related issues, ignition problems, or sensor malfunctions, the internal combustion engine will drag the powertrain with it during the stall. During such a stall, the vehicle will lose its propulsion ability and the vehicle will shut down. Some existing anti-stall strategies command an electric motor to hold the engine revolutions above engine idle to keep the engine running. Such a strategy is undesirable however as the battery drains quickly and the electric motor cannot keep the engine running. Accordingly, while such HEV's do work well for their intended purpose, there is a desire for improvement in the relevant art.

### SUMMARY

According to one example aspect of the invention, a powertrain that generates and transfers drive torque to a driveline of a hybrid electric vehicle is provided. The powertrain includes an internal combustion engine (ICE), at least one electric motor and a controller. The powertrain is configured to selectively deliver drive torque from at least one of the ICE and the at least one electric motor to drive wheels, the powertrain having a clutch that selectively disengages the ICE from a remainder of the powertrain. The controller is configured to determine a stall condition of the ICE; command the clutch to disengage the ICE based on a determination of the stall condition; command the ICE to restart; determine whether the ICE has restarted; and operate the powertrain in a hybrid mode based on confirmation that the ICE has restarted.

In some implementations, the controller is further configured to set a stall counter that counts occurrences of stall events; determine whether an amount of stall counts exceeds a threshold; and operate the powertrain in an electric drive mode based on a determination that the amount of stall counts exceeds the threshold.

In some implementations, the controller is further configured to send a signal to a human machine interface (HMI) in the vehicle indicative of a state of the powertrain.

In some implementations, the controller is further configured to determine whether the restart was successful; and operate the powertrain in a hybrid mode based on a successful restart of the ICE.

In some implementations, the controller further comprises an engine control system (ECS) that determines the stall condition.

In additional aspects, the controller further comprises a hybrid control system (HCS) that sends a disconnect signal indicative of the clutch to move to the open position.

In additional features, the controller further comprises a transmission control system (TCS) that receives the disconnect signal from the HCS and commands the clutch to move to the open position.

According to one example aspect of the invention, a method for controlling a powertrain that generates and transfers drive torque to a driveline of a hybrid electric vehicle is provided. The powertrain includes an internal combustion engine (ICE), and at least one electric motor, the powertrain configured to selectively deliver drive torque from at least one of the ICE and the at least one electric motor to drive wheels, the powertrain having a clutch that selectively disengages the ICE from a remainder of the powertrain. The method includes determining, at a controller, a stall condition of the ICE; commanding the clutch to disengage the ICE based on a determination of the stall condition; commanding the ICE to restart; determining, at the controller, whether the ICE has restarted; and operating the powertrain in a hybrid drive mode based on a confirmation that the ICE has restarted.

In additional features, the controller further sets a stall counter that counts occurrences of stall events; determines whether an amount of stall counts exceeds a threshold; and operates the powertrain in an electric drive mode based on a determination that the amount of stall counts exceeds the threshold.

In other features, the controller further sends a signal to a human machine interface (HMI) in the vehicle indicative of a state of the powertrain.

In additional features, the controller determines whether the restart was successful; and operates the powertrain in a hybrid mode based on a successful restart of the ICE.

According to other implementations, the method determining the stall condition comprises: receiving, at an engine control system (ECS), signals indicative of the ICE; and determining, at the ECS, the stall condition based on the signals.

In other features, commanding the clutch to disengage further comprises receiving, at a hybrid control system (HCS), a signal from the ECS indicative of the stall condition; and sending, from the HCS, a disconnect signal indicative of the clutch to move to the open position.

In other features, the method includes receiving, at a transmission control system (TCS), the disconnect signal from the HCS; and commanding the clutch to move to the open position.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a schematic diagram of an exemplary HEV having control system that decouples the internal combustion engine from a remainder of the driveline during a detected stall event and shown with various exemplary positions of electric motors in the HEV according to various principles of the present application;

FIG. 2 is schematic illustration of an exemplary HEV with a clutch that selectively engages the internal combustion engine with the drive wheels according to various principles of the present application; and

FIG. 3 is a logic flow diagram illustrating steps for operating the control system of FIG. 1 during a detected stall of the internal combustion engine according to examples of the present disclosure.

### DESCRIPTION

As discussed above, for HEV powertrain architectures, while in hybrid mode, a clutch needs to be closed to propagate engine torque to the drive wheels. In a scenario where the engine stalls and the engine speed drops to zero while connected to the driveline, the engine will drag the entire powertrain with it and the vehicle will lose its propulsion ability and the vehicle will shut down. Such an event will disable the driver from being able to drive the vehicle any further and the driver must pull over and attempt a key-crank to start the engine.

The instant disclosure provides a control system that recovers an engine stall event in the HEV with different hybrid powertrain architectures and hybrid types such as plug-in hybrid vehicles (PHEV's) and mild hybrids (MHEV's) to maintain vehicle drivability while attempting a restart of the engine without losing propulsion or shutting down the vehicle. The present disclosure leverages the ability of the hybrid powertrain to decouple the internal combustion engine from a remainder of the driveline and continue to drive in electric only mode for a predetermined amount of time.

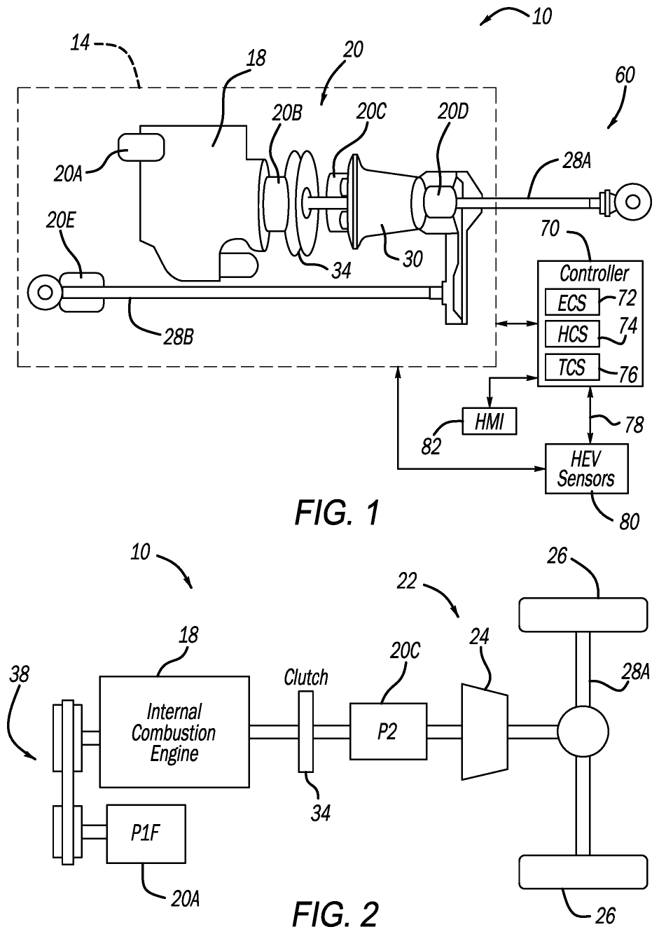

Referring now to FIGS. 1 and 2, a functional block diagram of an example hybrid electric vehicle 10 (also referred to herein as “vehicle 100”) according to the principles of the present application is illustrated. The vehicle 10 includes an electrified powertrain 14 generally including an internal combustion engine 18 and an electric motor 20. The vehicle 10 illustrates various configurations having various electric motors 20A, 20B, 20C, 20D and 20E. The electrified powertrain 14 is configured to deliver drive torque from the engine 18, from the electric motor 20, or any combinations thereof, through a driveline 22 including gearbox 24 and to drive wheels 26. The electrified powertrain 14 is shown in FIG. 2 configured to drive rear drive wheels 26 through a first driven axle 28A however, the electrified powertrain 14 can be configured to alternatively or additionally drive front drive wheels (not shown) through a second driven axle 28B.

The electrified powertrain 14 includes a transmission 30 and a clutch 34. The clutch 34 selectively disengages an output of the engine 18 from a remainder of the electrified powertrain 14. In examples, the electric motor 20A and 20B represents the starting motor for the engine 18 or belt starter generator (BSG), connected to the engine via a belt system 38. The motors 20C, 20D and 20E represent traction motors that can be used to deliver drive torque to the drive wheels 40 (such as during electric mode). As shown, the motors 20C, 20D and 20E are disposed at different positions in the powertrain 14. In general, the position of the motors 20C, 20D and 20E represents the type of hybrid architecture. For example, using motor 20A and 20C represents using motor 20A before the engine 18 and the motor 20C after the engine 18 but before (or within) the transmission 30. The electric motors 20A and 20B are generally less powerful than traction motors 20C, 20D and 20E and can be operated by the 12 volt or 48 volt power system of the vehicle 10.

A control system 60 for controlling operation of the electrified powertrain 14 includes a controller 70 that provides various inputs to the electrified powertrain 14. The controller 70 is shown having an engine control system (ECS) 72, a hybrid control system (HCS) 74, and a transmission control system (TCS) 76. The controller 70 receives signals 78 from hybrid electric vehicle sensors 80 indicative of various operating conditions of the powertrain 14. It is appreciated that the controller 70 can have additional controllers and/or modules for communicating signals to the electrified powertrain 14 within the scope of the present disclosure. The controller 70 can send signals to a human machine interface (HMI) 82 to display messages, fault codes, etc., indicative of various drive conditions related to the powertrain 14 specifically and of the vehicle 10 as a whole. The HMI 82 can be an instrument cluster, an infotainment device, a heads-up display, a handheld device (e.g., cellular phone) or any other device capable of communicating a message to a driver indicative of a drive state or other condition of the vehicle 10.

The HCS 74 oversees the states of operation of the vehicle 10 and allocates drive torque and speeds for all torque actuators (e.g., the internal combustion engine 18 and the electric motors 20). The HCS 74 commands opening and closing of the clutch 34 and manages shift execution during engine start conditions. The controller 70 implements the control strategy described herein based on the ability to disconnect the engine 18 from the driveline 22 (downstream of the clutch 34) and continue driving the vehicle 10 in electric mode.

The method of the present disclosure detects a stall of the engine 18 while the vehicle 10 is in hybrid mode with the engine 18 already running. The ECS 72 sends a signal or flag to the HCS 74 indicative of an engine stall event. The HCS recognizes the flag and starts an arbitration process to determine if the driveline 22 can safely disconnect from the engine 18. The HCS 74 will collapse the torque limits of the motor 20A to drop to zero so that it is no longer supporting the engine 18 to rotate. The HCS 74 commands the TCS 76 to disengage the clutch 34 and disconnect the engine 18 from the transmission 30 and the drive wheels 26.

The control strategy implemented herein is unique in that it provides engine disconnect capability on different hybrid architectures (e.g., any combinations of electric motors, such as motors 20A-20D). Once safety checks are evaluated and passed, the HCS 74 will command the ECS 72 to attempt a normal start cycle for the engine 18. The engine start then depends on the ECS 72 being able to enable fuel and sustain combustion. Once the engine speed exceeds a desired threshold for a specified amount of time, the HCS 74 will declare the engine 18 to be running. The HCS 74 can then command the TCS 76 to close the clutch 34 and connect the engine 18 to the driveline 22 to continue regular hybrid driving.

As described herein, the instant control strategy implements a counter in the controller 70. The counter keeps count of the attempts taken to restart the engine 18. If the engine 18 keeps stalling repeatedly, then it is safe to override it permanently off rather than drain the battery during repeated restart attempts. The counter increments every time a stall flag is detected from the ECS 72. A counter check is performed before attempting to restart the engine 18. If the counter has exceeded a certain threshold, then no more engine starts are allowed for that drive cycle and the engine 18 will be permanently turned off. The driver is notified of this remedial action via the HMI 82 informing the driver a message indicative of the situation such as “the vehicle performance might be limited”. Other messages may be displayed on the HMI 82.

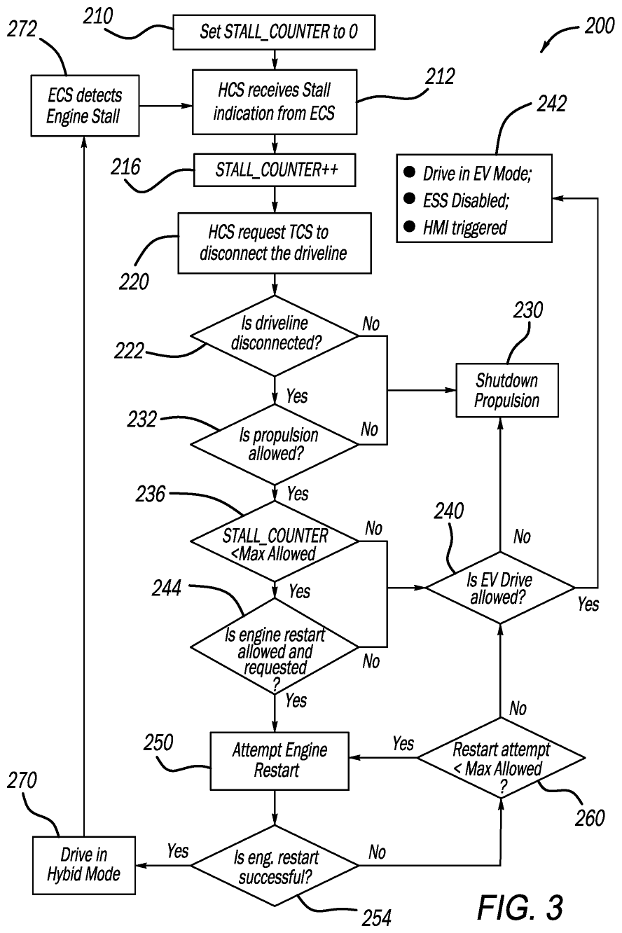

With additional reference now to FIG. 3, a method for operating the control system of FIG. 1 during a detected stall of the internal combustion engine 18 according to examples of the present disclosure is shown and generally identified at reference numeral 200. At 210 control sets a stall counter to zero. At 212 the HCS 74 receives a stall indication from the ECS 72. At 216, control adds a count to the stall counter. At 220 the HCS 74 requests the TCS 76 to disconnect the driveline 22. In examples, the TCS 76 sends a signal to the clutch 34 to move to an open position. At 222, control determines whether the driveline 22 is disconnected. If control determines that the driveline 22 is not connected, control shuts down propulsion at 230. If control determines that the driveline 22 is disconnected at 222, control determines if propulsion is allowed at 232. If control determines that propulsion is not allowed at 232, control shuts down propulsion at 230. If control determines that propulsion is allowed at 232, control determines if the stall counter is less than a maximum allowable count. If the stall counter is not less than the maximum allowed, control determines whether the vehicle 10 is suitable for driving at 240.

If the stall counter is less than a maximum allowed, control determines whether a restart of the engine 18 allowed and requested at 244. If not, control proceeds to 240. If yes, control attempts a restart of the engine 18 at 250. At 254 control determines whether the restart of the engine 18 was successful. If not, control proceeds to 260. If yes, control drives the vehicle 10 in hybrid mode at 270 and loops to 272 where the ECS determines whether an engine stall event has occurred.

If control determines that a restart attempt is not less than the maximum allowed at 260, control proceeds to 240. If control determines that the vehicle 10 is allowed to drive at 240, control proceeds to 242. At 242 control drives the vehicle 10 in Electric Vehicle (EV) mode, the engine start stop (ESS) is disabled and a signal is sent to the human machine interface indicative of the situation.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A powertrain that generates and transfers drive torque to a driveline of a hybrid electric vehicle, the powertrain comprising:
an internal combustion engine (ICE);
at least one electric motor;
the powertrain configured to selectively deliver drive torque from at least one of the ICE and the at least one electric motor to drive wheels, the powertrain having a clutch that selectively disengages the ICE from a remainder of the powertrain;
a controller that controls operation of the powertrain based on operating conditions, wherein the controller is configured to:
determine a stall condition of the ICE;
command the clutch to disengage the ICE based on a determination of the stall condition;
command the ICE to restart;
determine whether the ICE has restarted; and
operate the powertrain in a hybrid drive mode based on confirmation that the ICE has restarted.

2. The powertrain of claim 1, wherein the controller is further configured to:
set a stall counter that counts occurrences of stall events;
determine whether an amount of stall counts exceeds a threshold; and
operate the powertrain in an electric drive mode based on a determination that the amount of stall counts exceeds the threshold.

3. The powertrain of claim 2, wherein the controller is further configured to:
send a signal to a human machine interface (HMI) in the vehicle indicative of a state of the powertrain.

4. The powertrain of claim 1, wherein the controller is further configured to:
determine whether the restart was successful; and
operate the powertrain in a hybrid mode based on a successful restart of the ICE.

5. The powertrain of claim 1, wherein the controller further comprises:
an engine control system (ECS) that determines the stall condition.

6. The powertrain of claim 5, wherein the controller further comprises:
a hybrid control system (HCS) that sends a disconnect signal indicative of the clutch to move to the open position.

7. The powertrain of claim 6, wherein the controller further comprises:
a transmission control system (TCS) that receives the disconnect signal from the HCS and commands the clutch to move to the open position.

8. A method for controlling a powertrain that generates and transfers drive torque to a driveline of a hybrid electric vehicle, the powertrain including an internal combustion engine (ICE), and at least one electric motor, the powertrain configured to selectively deliver drive torque from at least one of the ICE and the at least one electric motor to drive wheels, the powertrain having a clutch that selectively disengages the ICE from a remainder of the powertrain, the method comprising:
determining, at a controller, a stall condition of the ICE;
commanding the clutch to disengage the ICE based on a determination of the stall condition;
commanding the ICE to restart;
determining, at the controller, whether the ICE has restarted; and
operating the powertrain in a hybrid drive mode based on confirmation that the ICE has restarted.

9. The method of claim 8, wherein the controller further:
sets a stall counter that counts occurrences of stall events;
determines whether an amount of stall counts exceeds a threshold; and
operates the powertrain in an electric drive mode based on a determination that the amount of stall counts exceeds the threshold.

10. The method of claim 9, wherein the controller further:
sends a signal to a human machine interface (HMI) in the vehicle indicative of a state of the powertrain.

11. The method of claim 8, wherein the controller further:
determines whether the restart was successful; and
operates the powertrain in a hybrid mode based on a successful restart of the ICE.

12. The method of claim 8, wherein determining the stall condition comprises:
receiving, at an engine control system (ECS), signals indicative of operating conditions of the ICE, and
determining, at the ECS, the stall condition based on the signals.

13. The method of claim 12, wherein commanding the clutch to disengage further comprises:
receiving, at a hybrid control system (HCS), a signal from the ECS indicative of the stall condition; and
sending, from the HCS, a disconnect signal indicative of the clutch to move to the open position.

14. The method of claim 13, further comprising:
receiving, at a transmission control system (TCS), the disconnect signal from the HCS; and
commanding the clutch to move to the open position.
